(19) United States
(12) Patent Application Publication
(10) Pub. No.: US 2020/0170201 A1
(43) Pub. Date: Jun. 4, 2020

(54) DEVICE FOR CONVEYING MUSHROOMS

(71) Applicants: DELFORT COMM. V., Meulebeke (BE); PD CONSULT COMM. V., Aartrijke (BE)

(72) Inventors: Pierre DELBEKE, Aartrijke (BE); Paul DELBEKE, Meulebeke (BE)

(21) Appl. No.: 16/612,260

(22) PCT Filed: May 8, 2018
(86) PCT No.: PCT/IB2018/053176

§ 371 Date: Nov. 8, 2019

(30) Foreign Application Priority Data
May 8, 2017 (BE) BE-2017/5323
Jul. 5, 2017 (BE) BE-2017/5478

(51) Int. Cl. A01G 18/70

(52) U.S. Cl. CPC A01G 18/70

(57) ABSTRACT

Device for conveying picked mushrooms (1), wherein this device comprises several openings (4) into which the mushrooms (1) are placeable, and comprises one or several displacement means configured to move these openings (4) from a picking zone to a removing zone where the mushrooms (1) placed into the openings (4) are removable, wherein this device comprises several conveying modules (5) which each comprise one or several said openings (4), and the displacement means at least comprise a first conveying unit (6a, 6b), (60a, 60b) for moving the conveying modules (5) to an intermediate point, and a second conveying unit (7), which joins to the first conveying unit (6a, 6b), (60a, 60b) at the location of the intermediate point, for moving the conveying modules (5) from the intermediate point to the removing zone.

This application is a National Phase entry of International Application No. PCT/IB2018/053176 under § 371 and claims the benefit of Belgian patent application No. BE-2017/5323, filed May 8, 2017, and BE-2017/5478, filed Jul. 5, 2017, which are hereby incorporated by reference in their entirety.

### FIELD OF THE DISCLOSURE

The present disclosure relates to a device for conveying picked mushrooms comprising a cap and a stem, such as champignon mushrooms, wherein this device comprises several openings through which the stem of a mushroom is placeable along a virtually downwardly directed receiving direction, and comprises one or several displacement means configured to move these openings from a picking zone, where the mushrooms are picked and placed into the openings, to a removing zone where the mushrooms placed into the openings are removable.

The present disclosure also relates to a commercial site where mushrooms, such as champignon mushrooms, are grown, this commercial site comprising such a device.

### BACKGROUND

Growing edible mushrooms on a commercial site, more specifically the cultivation of champignon mushrooms, takes place according to a certain cultivation cycle. Thus, this cultivation cycle comprises one or several preparatory phases and one or several harvesting phases.

At most commercial sites, cultivation currently starts with colonized substrate on which a layer of casing soil is spread. Colonized substrate is substrate which has been inoculated with mushroom mycelium, specifically champignon mushroom mycelium (champignon mushroom spawn), and wherein the mycelium has had time to (partly) colonize the substrate. In order to start cultivation, this colonized substrate is taken to a cultivation cell and a layer of casing soil is spread on top of this substrate. This is the start of the preparatory stages which take place before champignon mushrooms can be harvested. Here, the preparatory stages comprise the mycelium growth/mycelium stage and the button stage, respectively. During the mycelium stage, the mycelium grows from the colonized substrate through the casing soil. Thereafter, buttons are formed from the mycelium. This is the button stage. A harvesting stage is a period in which the champignon mushrooms are harvested. Harvesting is also referred to as ‘picking’.

After the button stage, the harvesting stages start. These harvesting stages are also referred to as flushes.

With the known cultivation methods, the said substrate is placed in trays or in beds. Beds (benches) are a kind of long trays on legs, in which the substrate is placed. These beds may be arranged in one layer, but may also be placed one on top of the other. In the latter case, this is referred to as a multi-layered substrate cultivation in beds. Cultivation in beds is relatively interesting from an economic point of view.

The cultivation of edible mushrooms, such as champignon mushrooms, is a labour-intensive cultivation. The reason for this is that harvesting the mushrooms, consisting of picking the mushrooms, has to be performed by hand if it is to be ensured that the mushrooms are of good quality. It is also possible to pick champignon mushrooms by machine, but the quality of these machine-picked champignon mushrooms is below par. These latter champignon mushrooms are therefore only suitable for the canning and/or freezing industry. When mushrooms are picked by hand, these can also be offered for sale on the fresh market.

With conventional cultivation systems, the pickers pick the mushrooms with one hand and use the other hand to cut the stem end, being the part of the stem which is furthest from the cap, using a small knife. The picked champignon mushrooms are placed in small boxes or bags, which are subsequently displaced.

In order to speed up manual picking, a picking belt is sometimes provided. The picking belt is then arranged next to and/or above the beds or trays. This picking belt is a conveyor belt comprising a belt with several openings into which the stem of a mushroom is placeable along a virtually downwardly directed receiving direction, and displacement means configured to move this belt from a picking zone, where the mushrooms are picked and placed into the openings, to a removing zone where the mushroom placed into the openings are removable. By means of such a picking belt, the transportation of the mushrooms is partly automated, resulting in cultivation becoming slightly less labour-intense. However, at the end of the picking belt, someone always has to remove the champignon mushrooms from the picking belt and put them in the desired packaging. In principle, the removal of the champignon mushrooms could be automated, but this would mean that there would have to be a robot/machine for each picking belt in order to remove the champignon mushrooms from the picking belt again.

### SUMMARY

It is therefore an object of some embodiments of the invention to further optimize the picking/the harvesting of mushrooms comprising a cap and a stem, such as champignon mushrooms, and to make this picking/harvesting less labour-intense.

This object may be achieved by providing a device for conveying picked mushrooms comprising a cap and a stem, such as champignon mushrooms, wherein this device comprises several openings through which the stem of a mushroom is placeable along a virtually downwardly directed receiving direction, and comprises one or several displacement means configured to move these openings from a picking zone, where the mushrooms are picked and placed into the openings, to a removing zone where the mushrooms placed into the openings are removable, wherein this device comprises several conveying modules, each of which comprising one or several of said openings and wherein a said opening provides access to or forms part of a passage which extends through the respective conveying module along the receiving direction, and the displacement means comprise at least a first conveying unit for moving the conveying modules to an intermediate point, and second conveying unit, which joins to the first conveying unit at the location of the intermediate point, for moving the conveying modules from the intermediate point to the removing zone, wherein the first conveying unit is configured to be at least partly arranged in the picking zone.

Here, the conveying modules are moved from the picking zone to the removing zone. The term picking zone is used to indicate the zone where the mushrooms are harvested and thus picked. The term removing zone is used to indicate the zone where the mushrooms are removed from the conveying modules again. Removing the mushrooms may be carried out, for example, by means of a robot. There are various cultivation methods to grow mushrooms on a commercial site. The cultivation methods which are currently used most, use trays or beds, in which colonized substrate is placed. These trays or beds are preferably arranged in a cultivation cell. In this case, the picking zone then forms part of the cultivation cell. However, it is also possible to take the trays and/or beds from the cultivation cell at the point in time when picking is about to be performed.

With this device, conveying modules are used which are moved by means of at least two different conveying units. Here, using conveying modules which are conveyable between conveying units results in a large degree of flexibility. The reason for this is that, in this case, the removing zone can be arranged in a different space from the space where the picking zone is situated. The reason for this is that it is simple to move conveying modules between different spaces by means of separate conveying units. One said conveying module may comprise, for example, one or two or three, etc. of said openings. The conveying module is then configured to move 1, 2, 3 or several mushrooms simultaneously, respectively. In this case, no packaging material should therefore be taken into the picking zone, thus reducing the risk of infection.

The first conveying unit may be configured to be arranged in such a way that the intermediate point is situated outside a said cultivation cell and the removing zone may be situated in one central space which is different from the said cultivation cell, with all picked mushrooms being moved to this central space by the second conveying unit.

The first and/or the second conveying unit may then be arranged such that the conveying modules automatically pass from the first conveying unit to the second conveying unit at the location of the intermediate point. Optionally, guide or push elements may be used which support a quick transfer. This may be a direct transfer, but, if desired, it is also possible to use an intermediate unit which transfers the conveying modules from the first conveying unit to the second conveying unit. Each conveying unit may, for example, comprise one or several conveyor belts, in which case these conveyor belts are then joined to each other and thus transfer the conveying modules between both conveying units. The conveying modules are then taken to the desired locations/zones via conveyor belts. Conveyor belts are simple and currently available.

The term receiving direction is used here to indicate the ideal direction in which the champignon mushrooms are placeable into the openings. The opening extends along a plane. The receiving direction preferably extends virtually at right angles to this plane. In order to make it as easy as possible to place the stems into the openings, the plane of the opening preferably extends virtually horizontally during use. The receiving direction then preferably corresponds to the vertical direction. This does not rule out that certain pickers will place the mushrooms at an angle to the receiving direction. This angle is preferably not greater than 20°, more preferably not greater than 10°. By placing the stems of the mushrooms into the openings virtually along the receiving direction, it is ensured that these mushrooms are arranged in the openings in a satisfactory manner and do not become damaged.

For a commercial site comprising several cultivation cells where picking takes place, a movable first conveying unit may be provided which is movable from the one cultivation cell to the other cultivation cell or one first conveying unit may be provided for each cultivation cell. If one first conveying unit is provided for each cultivation cell, then it is possible to provide, for example, one central second conveying unit to which the said first conveying units joins or are joinable, with this second conveying unit moving the conveying modules to a central removing zone. This central removing zone is then preferably arranged in a separate space. By means of such a device, the removal of the mushrooms may be centralized, even if there are several picking zones. A robot/machine which removes mushrooms from the conveying modules may be provided in the removing zone, thus greatly reducing the labour-intensity of mushroom cultivation.

By using a passage, mushrooms of different stem lengths can be placed into the openings correctly and rest on the conveying modules, and the mushrooms are then also easily movable by means of the conveying modules. If a said opening forms part of a passage, this means that yet another part of the passage may extend above the opening, viewed along the receiving direction. This part may then be adapted to receive and support the cap as well as possible.

In a preferred embodiment, the first conveying unit and the second conveying unit each comprise one or several conveyor belts in order to support and carry along the conveying modules. It is very easy to move conveying modules using conveyor belts on which the conveying modules are configured to rest. The second conveying unit may comprise, for example, at least one central conveyor belt on which all conveying modules end up, so that all conveying modules can then easily be taken to the removing zone. Preferably, certain conveyor belts are also movable, so that they can be put into action at the desired location. If cultivation takes place in beds, it is for example possible to provide at least one movable conveyor belt, so that this conveyor belt can be positioned at the location where picking takes place. At least one conveyor belt preferably comprises at least one belt and a frame, wherein this one belt is arranged so as to be movable around the frame. A belt may also be referred to as a string if it is sufficiently narrow. This conveyor belt is arranged such that the conveying unit can move from a point A to a point B by supporting the bottom side of this conveying module and carrying it from point A to point B. The conveying module then rests on the outer side of the conveyor belt at the location of the top part of the conveyor belt. Preferably, the bottom side of each conveying module, which is configured to come into contact with the conveyor belts, extends along a plane, so that the conveying module is supported by the conveyor belts in a stable manner.

Preferably, a said conveyor belt of the first conveying unit is configured to be joined to a said conveyor belt of the second conveying unit at the location of the intermediate point in order to transfer the conveying modules between the first and the second conveying unit.

Preferably, the device comprises at least two of said first conveying units, each of which joins to the said second conveying unit at the location of their said intermediate point. In a specific embodiment, the device comprises at least two sets of one or several first conveying units and the device comprises a said second conveying unit for each set of one or several conveying units. Both second conveying units are then preferably configured to move the conveying modules to the same removing zone. This device is then suitable for a commercial site which comprises several sets of one or several cultivation cells where picking takes place.

In a preferred embodiment, the openings extend along a plane and a maximum size of these openings is between 1.5 cm and 4.5 cm, so that, viewed along the receiving direction, the cap is configured to extend substantially on the top side of the opening. By in this case limiting the dimensions of the openings, the caps of the picked mushrooms will not be able to extend beyond the openings. This ensures that the mushrooms will securely rest on the conveying modules. During use of this device, the said plane extends preferably virtually horizontally. These openings are preferably circular and have a maximum diameter of between 1.5 cm and 4.5 cm. Stems are readily insertable into such openings and such openings do not comprise any sharp edges or corners which might cause damage to the stem. The openings may, for example, also be oval-shaped. Other shapes are also possible.

By in this case using separate conveying modules, it is readily possible to provide different types of conveying modules. Preferably, the device comprises at least two types of conveying modules, wherein the dimensions of the openings of these conveying modules differ from each other. The reason for this is the fact that the mushrooms which will be picked during cultivation will vary in size. This depends on the desired type that is to be picked, large, medium-sized or relatively small mushrooms, but it also depends on the period within the cultivation cycle. By in each case always using the desired type of conveying module, the appropriate opening through which a said stem can be fitted is always available. The different types of conveying modules may also be adapted to the type of cap, so that the cap is well-supported by the conveying module after the stem has been passed through a said opening.

Furthermore preferably, the device comprises a cutting unit comprising one or several cutting elements for cutting the stem ends which extend beyond the passage, viewed along the receiving direction. By in this case providing a cutting unit cutting the stem ends, these stem ends do not have to be cut by hand and pickers can use both hands for picking, as a result of which picking can proceed more smoothly and thus becomes less labour-intense. The one or several cutting elements are then preferably arranged such that the one or several cutting elements are situated on the bottom side of the conveying modules and can thus reach the stem ends which extend through the passage. The dimensions of the passage are then preferably such that a stem end virtually always extends beyond the passage after a mushroom has been passed through the opening. The device may comprise, for example, a collecting tray which is arranged under the cutting unit in order to collect the cut stem ends and/or the device may comprise an open or closed channel, which is arranged under the cutting unit in order to collect the cut stem ends and discharge them by means of water.

The first conveying unit preferably furthermore comprises a conveyor belt for supporting and carrying along the conveying modules, wherein this conveyor belt leaves access to the passages free. The expression access to the passages is used here to indicate that the bottom sides of the passages are free and thus that the stems of the mushrooms can extend beyond the bottom sides of the conveying modules. As the conveying modules will bear against the outer side of the conveyor belt, the cutting unit may then, for example, be configured in such a manner that it is arranged such that the one or several cutting elements are arranged on the inside of this conveyor belt at the location where the conveying modules are supported and carried along by this conveyor belt. In this way, the cutting elements are able to cut the stem ends which extend beyond the passage. A conveyor belt comprises at least one movable belt which moves around a frame or the like. Here, such conveyor belts are readily able to move conveying modules in which one or several mushrooms are arranged and in which a stem extends beyond the passage. By leaving the passages free, these stems then do not hamper the transportation of the conveying modules and the conveying modules can rest securely on the conveyor belt. By already cutting the stem ends extending beyond the passages at the location of the first conveying unit, it is possible to provide standard conveyor belts having, for example, uninterrupted or continuous belts for the second conveying unit, as the mushrooms will virtually no longer extend beyond the passage once the stem end has been cut. It is then possible, for example, to provide one central second conveying unit to which one or several first conveying units are configured to be joined during use of this device.

Said conveyor belt may comprise, for example, at least two conveying strings which are spaced apart and arranged virtually parallel to each other, wherein the conveying modules are configured to rest on both conveying strings. In this case, a space extends between both conveying strings. In this case, the conveying modules and the distance between both conveying strings may be adapted to the dimensions of the passage, so that the stems can then extend between both conveying strings. In this case, the one or several cutting elements are preferably arranged such that they cut the stems just below the part of these conveying strings on which the conveying modules are positioned, viewed along the receiving direction.

It is, for example, also possible to provide a said conveyor belt comprising holes, wherein the passages of the conveying modules are configured to extend above these holes. Thus, a belt with holes and positioning elements, such as projecting elements, may be provided, in which case these positioning elements will always carry the conveying modules along in a position in which the passages are situated above these holes.

Preferably, the one or several cutting elements are configured to be arranged at the location of the first conveying unit in order to cut the stem ends which extend beyond the passages at the location of the first conveying unit.

In an alternative embodiment, the second conveying unit comprises a conveyor belt in order to support and carry along the conveying modules, in which case this conveyor belt leaves the access to the passages free, and the cutting unit and the second conveying unit are configured to be arranged in such a way that the one or several cutting elements are arranged on the inside of the conveyor belt at the location where the conveying modules are supported and carried along by the conveyor belt.

The one or several cutting elements are preferably rotatably arranged. Thus, the one or several cutting elements may be arranged so as to be rotatable about a rotation axle which preferably virtually extends along the receiving direction. The cutting of a stem end by means of a rotating blade or the like is very quick. Preferably, during use of the device, the said opening extends along a plane which extends virtually horizontally and preferably the receiving direction extends at right angles to this plane. By in this case then providing cutting elements which rotate around a rotation axle which extends along the receiving direction, the stem ends are also cut horizontally. The one or several cutting elements may also be (metal) strings which form a closed loop, in which case this loop is driven.

Each cutting unit preferably comprises at least two cutting elements, wherein these cutting elements are, for example, small discs which partly overlap each other during rotation about their rotation axles. The conveying modules normally move in the direction of these cutting elements. Due to the overlap and a rotating movement, the cutting elements then position the stems and carry these along during the cutting of the stem ends, as a result of which the cutting of the stem ends can take place very quickly and smoothly.

Also furthermore preferably, the cutting unit comprises one or several guide elements for guiding the conveying modules past the one or several cutting elements. This ensures that the stem ends are reliably cut and that the mushrooms will not move excessively with respect to their conveying modules during the cutting of the stem ends. In this way, these guide elements may for example comprise guide wheels in order to accurately position the conveying modules and guide them past the one or several cutting elements. These guide wheels are preferably rotatable about an axle which virtually extends along the receiving direction and these guide wheels may or may not be driven.

In a preferred embodiment, a said passage comprises a cap space which, viewed along the receiving direction, extends on the top side of the opening, in which case the cap is configured to at least partly extend into the cap space. Preferably, the cap is configured to extend largely or substantially into the cap space. The cap then rests on the conveying module, at least at the location of the cap space, as a result of which the mushroom is securely held in the desired position while the conveying module is moving. The quality of the mushrooms is consequently reliably maintained.

Still more preferably, the dimensions of the cap space, viewed along a plane at right angles to the receiving direction, decrease towards the opening. Mushrooms of different sizes and thus different stem lengths may then be arranged in such a way that virtually the same length of the stem, viewed along the receiving direction, extends beyond the opening and thus optionally beyond the passage. If the device also comprises a cutting unit, this prevents the volumes of the cut stem ends from being very large, thus benefiting the efficiency of the cultivation. These dimensions may decrease continuously, as a result of which the walls of the cap space form a slope in the direction of the opening. The shape of the cap space may have, for example, a frustoconical shape. The shape of the passage beyond the opening, viewed along the receiving direction, may then be cylindrical.

Also preferably, the dimension of the passage, viewed along the receiving direction and measured from the opening and in a downward direction, is between 0.1 and 3 cm. As a result thereof, there is sufficient space for the stem to extend, so that the mushroom maintains its desired position while the conveying module is moving. The dimension is not too great either, so that there is always a part of the stem which extends beyond the passage and is thus cuttable by means of a said cutting unit.

A section of a said conveying module at right angles to the receiving direction is preferably oval-shaped. Preferably, all sections of the conveying module at right angles to the receiving direction are virtually oval-shaped. Oval-shaped conveying modules are easily movable between different conveyor belts and can also readily be guided by one conveyor belt and between two successive conveyor belts. Neither will they start to rotate undesirably about an axle extending along the receiving direction. At the location of the removing zone, the second conveying unit may then have a conveyor belt where all conveying modules are placed in one line and are moved behind each other one by one. Arranging oval-shaped conveying modules in one line is simple. However, it is also possible to provide a conveying module having a section at right angles to the receiving direction which is circular, has the shape of a polygon, such as a rectangle, etc. If the section is a polygon, then the corners are preferably rounded.

The conveying modules are preferably substantially made of plastic or metal. In this case, these conveying modules have a certain strength and are not susceptible to breaking, or less so. Conveying modules are also readily cleanable, which benefits hygiene.

In a highly preferred embodiment, the displacement means comprise at least a third conveying unit for moving conveying modules from the removing zone back to a said picking zone. By means of a third conveying unit, it is easy to return the conveying modules, which were taken to the removing zone by the second conveying unit in order to remove the mushrooms from the conveying modules, to the first conveying units, so that the conveying modules can be filled again with mushrooms. In this way, a continuous system is achieved, as a result of which picking will take place very smoothly. Preferably, the device in this case is a completely closed system which can operate autonomously.

This object of embodiments of the present invention may also be achieved by providing a commercial site for growing mushrooms, such as champignon mushrooms, comprising a cap and a stem, wherein this commercial site comprises a device as illustrated above, and wherein this commercial site comprises a first cultivation cell, wherein this first cultivation cell comprises a said picking zone in which the mushrooms are picked, wherein the first conveying unit is at least partly arranged in this picking zone, and in that this commercial site comprises a collecting space, wherein this collecting space comprises the said removing zone. The picking zone is then preferably arranged in a space which differs from the collecting space. The collecting space may also be referred to by the term packaging space.

Preferably, this commercial site comprises several cultivation cells in which mushrooms are picked. The commercial site and the device may then, for example be configured as follows.

The commercial site may for example comprise a central corridor which gives access to two or several cultivation cells and which gives access to a packaging space.

These cultivation cells contain one or several beds in which mushrooms are grown and picked. For each cultivation cell, there is a first conveying unit, wherein each first conveying unit comprises at least one picking conveyor belt which is configured to be arranged at the location of a said bed, so that pickers can place mushrooms in the conveying modules which are moved by means of the picking conveyor belt. Furthermore, every cultivation cell comprises a cutting unit which is arranged at the location of the first conveying unit. Each first conveying unit ends in the corridor by means of an end which joins to a conveyor belt of the second conveying unit, which is at least partly arranged in the corridor. In this case, this end forms the said intermediate point. For the cultivation cells in which picking takes place, there is always a conveyor belt of the first conveying unit which joins to the said conveyor belt of the second conveying unit.

This second conveying unit then carries the conveying modules along to the packaging space and this packaging space contains an installation which removes the mushrooms from the conveying modules at the location of the said removing zone. The device then preferably furthermore comprises a third conveying unit having one or several conveyor belts which takes the conveying modules back from the removing zone to a said picking conveyor belt.

In a preferred embodiment, the said intermediate point is situated outside the first cultivation cell and the picked mushrooms are moved to the collecting space by the second conveying unit.

Also preferably, the commercial site comprises several first cultivation cells in which picking takes place and the commercial site comprises at least one movable first conveying unit which is movable from the one first cultivation cell to the other cultivation cell.

In another specific embodiment, the commercial site comprises several first cultivation cells in which picking takes place and the commercial site comprises one first conveying unit for each first cultivation cell and the commercial site comprises one central second conveying unit to which the said first conveying units join or are joinable.

Preferably, the commercial site comprises a central corridor which provides access to two or several of said first cultivation cells and which provides access to the collecting space.

Furthermore preferably, the first conveying unit ends in the corridor, the second conveying unit comprises a conveyor belt which is at least partly arranged in the corridor and the first conveying unit joins to the second conveying unit at the location of the corridor.

### BRIEF DESCRIPTION OF THE DRAWINGS

The present invention will now be explained in more detail by means of the following detailed description of a preferred embodiment of a device according to the present invention. The sole aim of this description is to give illustrative examples and to indicate further advantages and features and can therefore by no means be interpreted as a limitation of the area of application of the invention or of the patent rights defined in the claims.

In this detailed description, reference numerals are used to refer to the attached drawings, in which:

FIG. 1 shows a diagrammatic representation of a commercial site comprising a device for moving picked champignon mushrooms, according to a first embodiment of the invention;

FIG. 2 shows a diagrammatic representation of a commercial site comprising a device for moving picked champignon mushrooms, according to a second embodiment of the invention;

FIG. 3 shows a top view of a first embodiment of a conveying module according to the invention;

FIG. 4 shows a top view of a second embodiment of a conveying module according to the invention;

FIG. 5 shows a section of the conveying module illustrated in FIG. 4;

FIG. 6 shows the section from FIG. 5, in which a small champignon mushroom is placed into the opening;

FIG. 7 shows the section from FIG. 5, in which a large champignon mushroom is placed into the opening;

FIG. 8 shows a diagrammatic representation of a top view of a first embodiment of a cutting unit according to the invention, in which the direction of rotation is illustrated by arrows;

FIG. 9 shows a diagrammatic representation of a top view of a second embodiment of a cutting unit according to the invention, in which the direction of rotation is illustrated by arrows;

FIG. 10 shows a section of the conveying module illustrated in FIG. 4 at the location of a cutting unit, as illustrated in FIG. 8, in which the conveying module is supported by two conveying strings of the first conveying unit.

### DETAILED DESCRIPTION

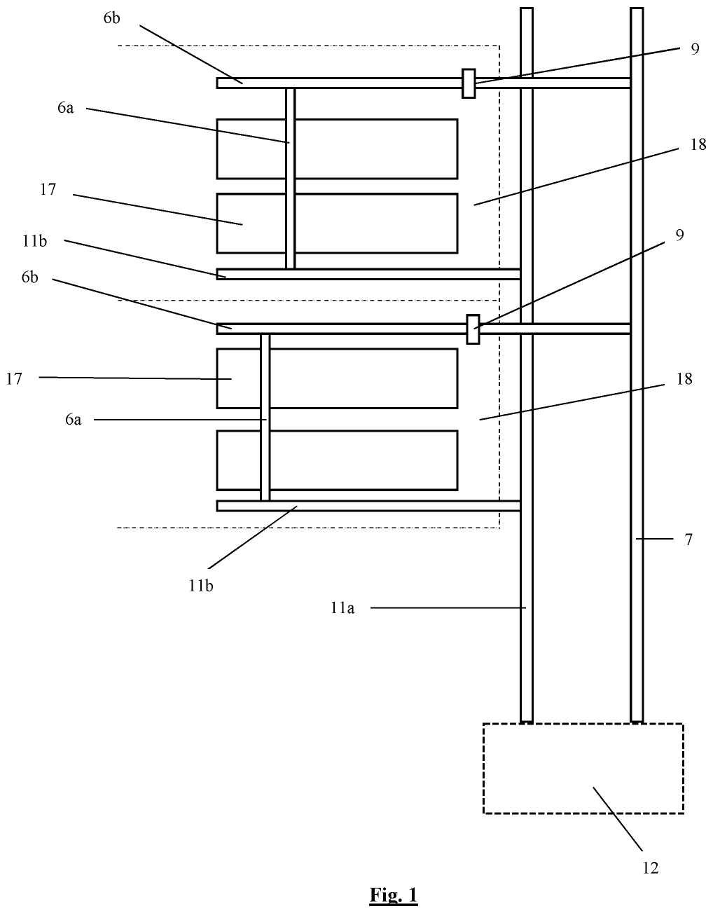

FIGS. 1 and 2 are diagrammatic representations of a part of a commercial site where champignon mushrooms (1) are grown. Champignon mushrooms (1) comprise a cap (2) and a stem (3). These commercial sites comprise a device for conveying champignon mushrooms (1) according to an embodiment of the invention. FIG. 1 diagrammatically illustrates a first embodiment of such a device. FIG. 2 diagrammatically illustrates a second embodiment of such a device.

On these commercial sites, the cultivation of champignon mushrooms (1) takes place by means of beds (17) in which colonized substrate and casing soil are placed. To this end, these commercial sites comprise several cultivation cells (18) which contain beds (17). The figures in each case show two cultivation cells (18) in which champignon mushrooms (1) are picked. In all likelihood, picking is not taking place in all cultivation cells (18). In some cultivation cells (18), for example, only preparatory stages take place, such as the mycelium stage and/or the button stage. In those cases, use is made of pulling systems in order to move the crop between at least two cultivation cells (18).

The commercial sites illustrated in FIGS. 1 and 2 are constructed in the same way. Thus, they each comprise a central corridor and cultivation cells (18) which end in the corridor via a closeable opening. These openings are at least partly open when picking takes place in the cultivation cells (18). In addition, the commercial site comprises a collecting space (12) which is linked to the corridor. In other words, the corridor can be brought into contact with the cultivation cells (18) and with the collecting space (12).

Both devices illustrated here each comprise the following elements:
several conveying modules (5) which each comprise one or several openings (4), through which the stem (3) of a champignon mushroom (1) is placeable along a virtually downwardly directed receiving direction (A),
a first conveying unit (6a, 6b), (60a, 60b) comprising a first (6a, 60a) and a second conveyor belt (6b, 60b) which join to each other, for moving the conveying modules (5) to an intermediate point, wherein the conveying modules (5) are configured to rest on the conveyor belts (6a, 6b, 60a, 60b),
a second conveying unit (7) comprising one conveyor belt (7) which joins to each second conveyor belt (6b, 60b) of each first conveying unit (6a, 6b), (60a, 60b) at the location of the said intermediate point, for moving the conveying modules (5) from the intermediate point to a removing zone, wherein the conveying modules (5) are configured to rest on the conveyor belt (7);
a third conveying unit (11a, 11b) comprising a feed conveyor belt (11a) which joins to the removing zone for moving the conveying modules (5) from the removing zone in the direction of the cultivation cells (18) and a distributor conveyor belt (lib) for each cultivation cell (18) which joins to the feed conveyor belt (11a) for taking the conveying modules (5) from the feed conveyor belt (11a) into the respective cultivation cell (18), wherein the conveying modules (5) are configured to rest on these conveyor belts (11a, 11b). These distributor conveyor belts (11b) are each joined to the first conveyor belt (6a, 60a) of the respective first conveying unit (6a, 6b), (60a, 60b);
a cutting unit (9) in each cultivation cell (18) to cut the stem ends of the champignon mushrooms (1) which are furthest from the cap (2) and extend beyond the conveying modules (5).

One of the said two conveyor belts (6a, 60b) of the first conveying unit (6a, 6b), (60a, 60b) is placed at the location of the bed/the beds (17) where picking takes place, i.e. is placed at the location of the said picking zone. When conveying modules (5) are moved by means of this conveyor belt (6a, 60b), champignon mushrooms (1) are placed in the openings (4).

By means of this device, the conveying modules (5) are thus moved from a picking zone to the removing zone and then back to a picking zone. By means of this device, it is possible to pick continuously.

In this case, the removing zone is arranged in the collecting space (12). This is one space (12) where all the picked champignon mushrooms (1) are gathered together. This means that it is easy to mechanize the removal of the champignon mushrooms (1) from the conveying modules (5), as only one machine/robot has to be provided here which removes the picked champignon mushrooms (1). This also means that sorting the champignon mushrooms (1) with regard to size and quality is easier and quicker.

Each cutting unit (9) is arranged at the location of the second conveyor belt (6b, 60b) of the first conveying unit (6a, 6b), (60a, 60b) between the picking zone and the intermediate point.

As is illustrated in FIG. 1, each first conveying unit (6a, 6b) comprises a first conveyor belt (6a) which joins to the respective distributor conveyor belt (11b) of the third conveying unit (11a, 11b) and extends across the two beds (17). This first conveyor belt (6a) is movable along a length direction of these beds (17), so that this can be moved to the zone of the beds (17) where picking takes place, i.e. to the picking zone. At the location of the first conveyor belt (6a), the picked champignon mushrooms (1) are placed into the conveying modules (5) and these conveying modules (5) are moved along in the direction of the second conveyor belt (6b). The first conveyor belt (6a) joins to the second conveyor belt (6b) of the first conveying unit (6a, 6b). From the first conveyor belt (6a), the conveying modules (5) are then transferred to the second conveyor belt (6b) which moves the conveying modules (5) to the respective intermediate point. The cutting unit (9) is arranged in such a way at this second conveyor belt (6b) that the stem ends are cut when these are conveyed by the second conveyor belt (6b). Since, with both conveyor belts (6a, 6b) of the first conveying unit (6a, 6b), the stems (3) go beyond the conveying modules (5), viewed along the receiving direction (A) (see below), each of these conveyor belts (6a, 6b) is made up of two conveying strings (20) which extend parallel to and at a distance from each other. Thus, the conveying modules (5) rest on these conveying strings (20) while they are being moved by these conveying strings (20) in such a way that the openings (4) extend between these two conveying strings (20), so that the stems (3) can extend between these conveying strings (20).

As is illustrated in FIG. 2, each first conveying unit (60a, 60b) comprises a first conveyor belt (60a) which joins to the respective distributor conveyor belt (11b) of the third conveying unit (11a, 11b) and extends next to both of the two beds (17). This first conveyor belt (60a) joins to a second conveyor belt (60b) of the first conveying unit (60a, 60b), wherein this second conveyor belt (60b) extends at the location of a bed (17), viewed along the length direction of the beds (17), and is also movable at right angles to this length direction, so that this second conveyor belt (60b) can be moved to the zone of the beds (17) where picking takes place, i.e. to the picking zone. At the location of the second conveyor belt (60b), the picked champignon mushrooms (1) are placed in the conveying modules (5). With this second conveyor belt (60b), the cutting unit (9) is arranged in such a way that the stem ends are cut when these are conveyed by the second conveyor belt (60b). Since, with the second conveyor belt (60b) of the first conveying unit (60a, 60b), the stems (3) go beyond the conveying modules (5), viewed along the receiving direction (A) (see below), this conveyor belt (60b) consists of two conveying strings (20) which extend parallel to and at a distance from each other. Thus, the conveying modules (5) rest on these conveying strings (20) while they are being moved by this second conveyor belt (60b) in such a way that the openings (4) extend between these two conveying strings (20), so that the stems (3) can extend between these conveying strings (20).

The junction between two joined conveyor belts (6a, 6b, 60a, 60b, 7, 11a, 11b) may be optimized by means of pushing elements and/or guide elements which conduct the conveying modules (5) during the transition between two conveyor belts (6a, 6b, 60a, 60b, 7, 11a, 11b).

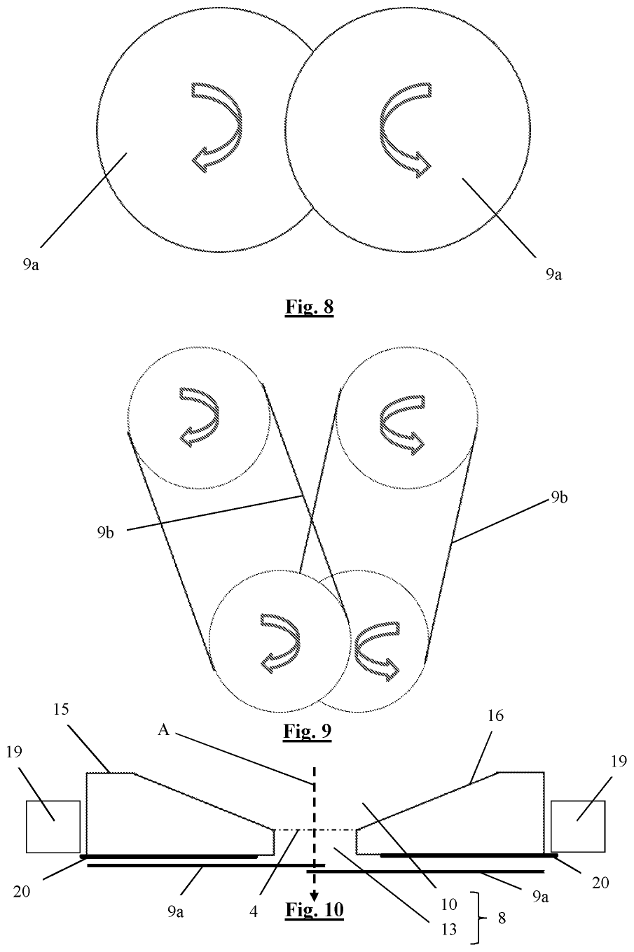

FIGS. 8 and 9 show two possible embodiments of cutting units (9). FIG. 8 shows a cutting unit (9) comprising two rotating small discs (9a) which each rotate about a rotation axle which extends along the receiving direction (A) and these small discs (9a) partly overlap each other. FIG. 10 shows a conveying module (5) at the location of this cutting unit (9). As is illustrated in FIG. 10, this cutting unit (9) comprises additional guide wheels (19) which rotate about a rotation axle which extends virtually along the receiving direction (A) and which guide the conveying modules (5) along the small discs (9a). FIG. 8 shows a cutting unit (9) comprising two metal strings (9b) which are each driven by two wheels which rotate about a rotation axle which extends along the receiving direction (A).

There are different types of conveying modules (5). Each type of conveying module (5) may also be provided with the desired dimensions. The conveying modules (5) illustrated here are small blocks having a top side (15) and a flat bottom side (14), each comprising one or several passages (8) which extend through the conveying modules (5) from the top side (15) to the bottom side (14) and extend along the receiving direction (A). These passages (8) comprise the said openings (4). Each passage (8) consists of a cap space (10) which, viewed along the receiving direction (A), extends above the opening (4) and a stem space (13) which extends below the opening (4). The dimensions of the conveying modules (5) are adapted to the dimensions of the champignon mushrooms (1) which are picked and are configured to be placed in these conveying modules (5) in such a way that the cap (2) cannot move beyond the opening (4) and only a stem (3) is placeable into the opening (4) and is furthermore such that a stem (3) virtually always extends beyond the conveying module (5), viewed along the receiving direction (A). The cap space (10) has a frustoconical shape whose dimensions decrease in the direction of the opening (4) and the adjoining stem space (13) has a cylindrical stem space (13). Due to the shape of the cap space (10), the cap space (10) has a slope (16) on which the champignon mushrooms (1) can rest and each champignon mushroom (1), irrespective of its size, will extend virtually to the same degree beyond the bottom side (14) of the conveying modules (5) so that the cut stem end is not too large.

Due to the fact that the bottom side (14) of each conveying module (5) is flat, a conveying module (5) van very easily be moved, when there are no champignon mushrooms (1) in the one or several openings (4) or when the stem end has already been cut by the cutting unit (9), using full, uninterrupted conveyor belts, being a conveyor belt without holes and conveyor belts which only comprise 1 belt. The reason for this is that, in this case, the flat bottom side (14) can rest securely on a conveyor belt. The conveyor belts of the second conveying unit (7) and the third conveying unit (11a, 11b) are therefore preferably always full conveyor belts (7, 11a, 11b).

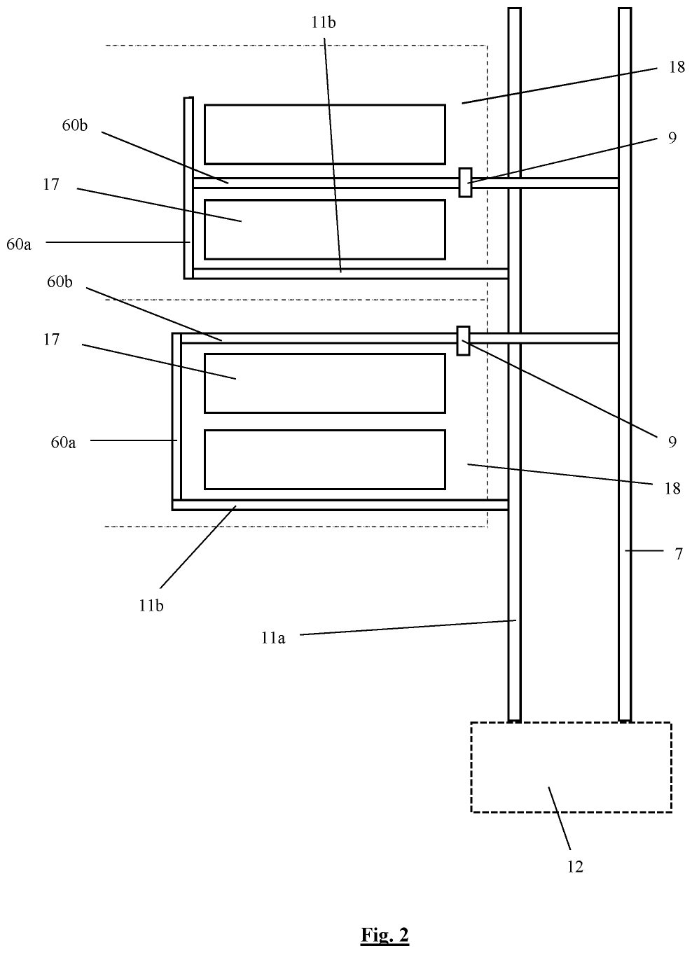

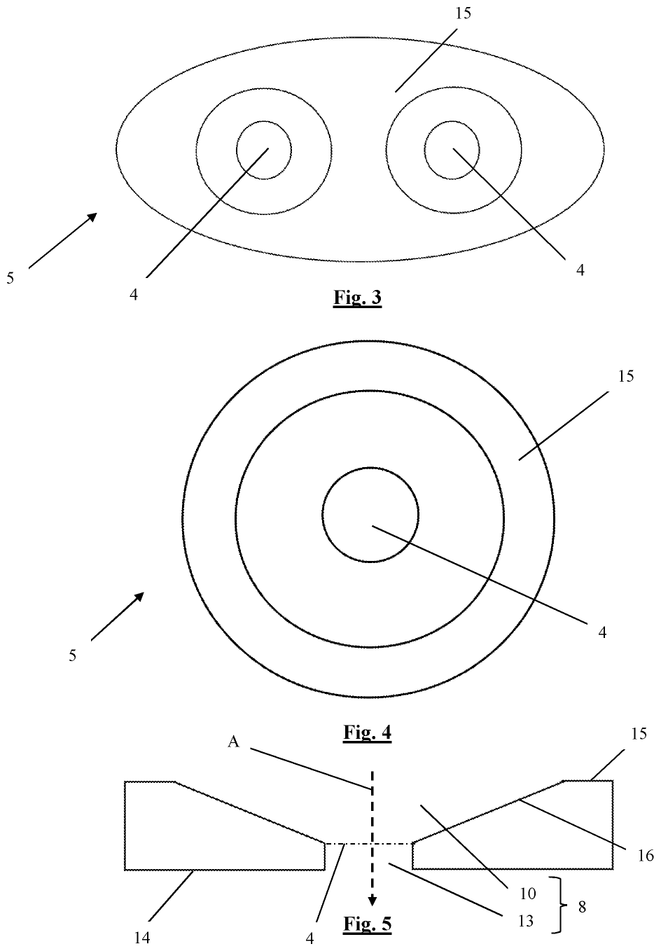

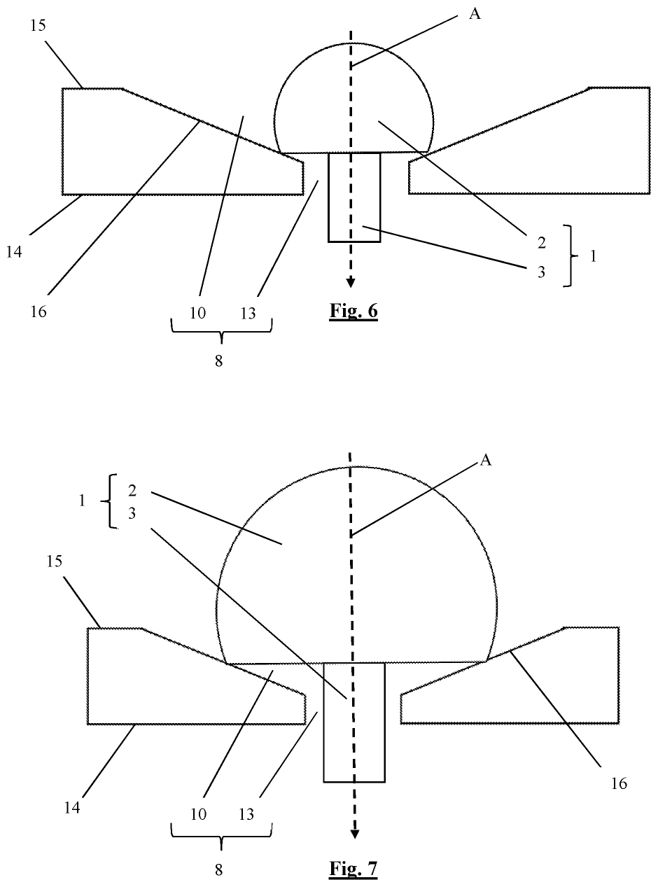

The conveying module (5) illustrated in FIG. 3 is an oval-shaped small disc having two openings (4) and thus two passages (8). The conveying module (5) illustrated in FIG. 4 is a small circular disc having 1 central passage (8) with the said opening (4). FIG. 5 shows a section of the conveying module (5) illustrated in FIG. 4 and in FIGS. 6 and 7 this section is illustrated with a champignon mushroom (1) placed into this conveying module (5) and before the stem end is cut which extends beyond the passage (8).

If the sensors (3) are correctly adjusted, it is possible in this case to increase the weight efficiency of the picked mushrooms by more than 5% or even more than 10 or 15%, compared to existing removing devices.

1. A device for conveying picked mushrooms having a cap and a stem, such as champignon mushrooms, comprising:
several openings through which a stem of a mushroom is placeable along a virtually downwardly directed receiving direction;
one or several displacers means configured to move these openings from a picking zone, where the mushrooms are picked and placed into the openings, to a removing zone where the mushrooms placed into the openings are removable; and
several conveying modules, each comprising one or several of said openings;
wherein a said opening provides access to or forms part of a passage which extends through the respective conveying module along the receiving direction;
wherein the displacers comprise at least a first conveying unit configured to move the conveying modules to an intermediate point, and a second conveying unit, which joins to the first conveying unit at the location of the intermediate point, configured to move the conveying modules from the intermediate point to the removing zone;
wherein the first conveying unit is configured to be at least partly arranged in the picking zone.

2. The device according to claim 1, characterized in that the first conveying unit and the second conveying unit each comprise one or several conveyor belts for supporting and carrying along the conveying modules.

3. The device according to claim 2, characterized in that a said conveyor belt of the first conveying unit is configured to be joined to a said conveyor belt of the second conveying unit at the location of the intermediate point in order to transfer the conveying modules between the first and the second conveying unit.

4. The device according to claim 2, characterized in that at least a said conveyor belt comprises at least one belt and a frame, wherein this one belt is arranged so as to be movable around the frame.

5. The device according to claim 1, characterized in that the device comprises at least two said first conveying units, each of which joins to the said second conveying unit at the location of their said intermediate point.

6. The device according to claim 1, characterized in that the openings extend along a plane and a maximum size of these openings is between 1.5 cm and 4.5 cm, so that, viewed along the receiving direction, the cap is configured to extend substantially on a top side of the opening.

7. The device according to claim 1, characterized in that the device comprises at least two types of conveying modules, wherein preferably the dimensions of the openings of these conveying modules differ from each other.

8. The device according to claim 1, characterized in that the device comprises a cutting unit comprising one or several cutting elements for cutting a stem end which extends beyond a said passage, viewed along the receiving direction (A).

9. The device according to claim 8, characterized in that the first conveying unit comprises a conveyor belt for supporting and carrying along the conveying modules, wherein this conveyor belt leaves access to the passages free.

10. The device according to claim 9, characterized in that the conveyor belt comprises at least two conveying strings which are spaced apart and arranged virtually parallel next to each other, wherein the conveying modules are configured to rest on both conveying strings.

11. The device according to claim 9, characterized in that the conveyor belt (6a, 6b, 60b) comprises holes, wherein the passages of the conveying modules are configured to extend above these holes.

12. The device according to claim 8, characterized in that the one or several cutting elements are intended to be arranged at a location of the first conveying unit in order to cut the stem ends which extend beyond the passages at the location of the first conveying unit.

13. The device according to claim 1, characterized in that a section of a said conveying module at right angles to the receiving direction is oval-shaped.

14. The device according to one of the preceding claims, characterized in that the displacers comprise at least a third conveying unit for moving conveying modules from the removing zone back to a said picking zone.

15. A commercial site for growing mushrooms, such as champignon mushrooms, comprising a cap and a stem, wherein this commercial site comprises:
the device according to claim 1; a first cultivation cell; and
a separate collecting space;
wherein this first cultivation cell comprises a said picking zone in which the mushrooms are picked;
wherein the first conveying unit is configured to be at least partly arranged in said picking zone; and
wherein said collecting space comprises a said removing zone.

16. The commercial site according to claim 15, characterized in that the said intermediate point is situated outside the first cultivation cell and the picked mushrooms are moved to the collecting space by the second conveying unit.

17. The commercial site according to claim 15, characterized in that the commercial site comprises several first cultivation cells in which picking takes place and the commercial site comprises at least one movable first conveying unit which is movable from one first cultivation cell to another first cultivation cell.

18. The commercial site according to claim 15, characterized in that the commercial site comprises several first cultivation cells in which picking takes place and the commercial site comprises one first conveying unit for each first cultivation cell and the commercial site comprises one central second conveying unit to which the said first conveying units join or are joinable.

19. The commercial site according to claim 15, characterized in that the commercial site comprises a central corridor which provides access to two or several said first cultivation cells and which provides access to the collecting space.

20. The commercial site according to claim 19, characterized in that the first conveying unit ends in the corridor, the second conveying unit comprises a conveyor belt which is at least partly arranged in the corridor and the first conveying unit joins to the second conveying unit at a location of the corridor.
